(19) United States
(12) Patent Application Publication
(10) Pub. No.: US 2011/0188959 A1
(43) Pub. Date: Aug. 4, 2011

(54) METHOD FOR PRODUCING A PREFABRICATED PART FROM AN UNMACHINED PART BY MEANS OF A MILLING TOOL

(75) Inventors: Peter Brambs, Muenchen (DE); Eike Jung, Freital (DE); Josef Koch, Muenchen (DE)

(73) Assignee: OPEN MIND TECHNOLOGIES AG, Wessling (DE)

(21) Appl. No.: 13/054,535

(22) PCT Filed: Jul. 14, 2009
(86) PCT No.: PCT/EP2009/005118

§ 371 Date: Apr. 19, 2011

(30) Foreign Application Priority Data
Jul. 15, 2008 (DE) 10 2008 033 130.9

(51) Int. Cl. B23C 3/00

(52) U.S. Cl. 409/132

(57) ABSTRACT

The invention relates to a method for producing a prefabricated part (1) from an unmachined part (2) by means of a milling tool (3). Said milling tool (3), when plunged into the material of the unmachined part (2), is automatically tilted in the advancing direction and/or laterally to the advancing direction in relation to the immersion path (4) that deviates from the direction (5) of the milling tool (3) that is machined immediately thereafter.

The invention relates to a method for producing a prefabricated part from an unmachined part by means of a milling tool.

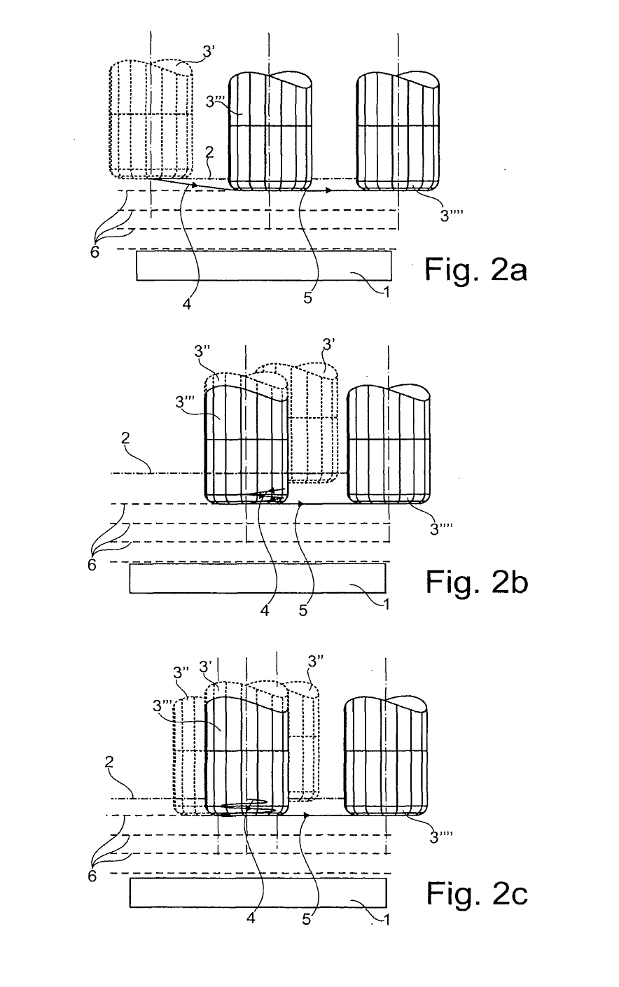

A special movement guidance of the milling tool is usually of particular importance for immersing the milling cutter into a material to be processed when the milling tool must axially reach large advancing depths with mostly front face contact. For milling processes with large advancing depths into the material—for example in roughing—various methods have been used in practice. Often the material is previously removed at the starting point in a separate operation—usually by drilling—so that the starting point for processing may be axially reached without material removal.

Where it is not possible to specify defined immersion points or pre-process them, an additional ramp-shaped or helical milling tool path is calculated beginning from the contour of the unmachined part towards the starting point via which the milling tool gradually approaches the following processing level or tangent plane at the first track point at a low angle. Examples of processing with a fixed milling tool axis are shown in FIGS. 2a to 2c. As a comparable example, reference is made to the processing method and processing device known from DE 199 03 216 A1. There is no change in the tool orientation during the advancing motion.

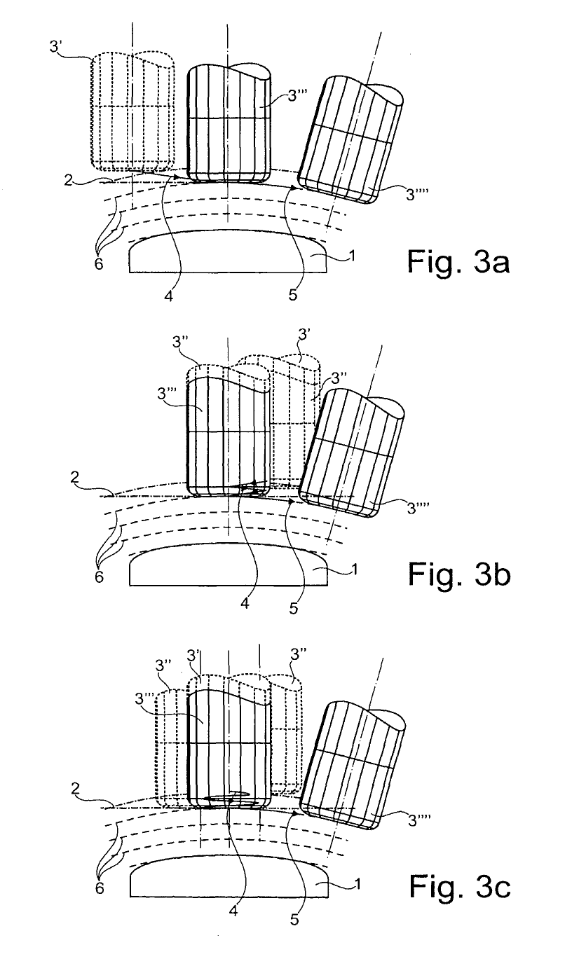

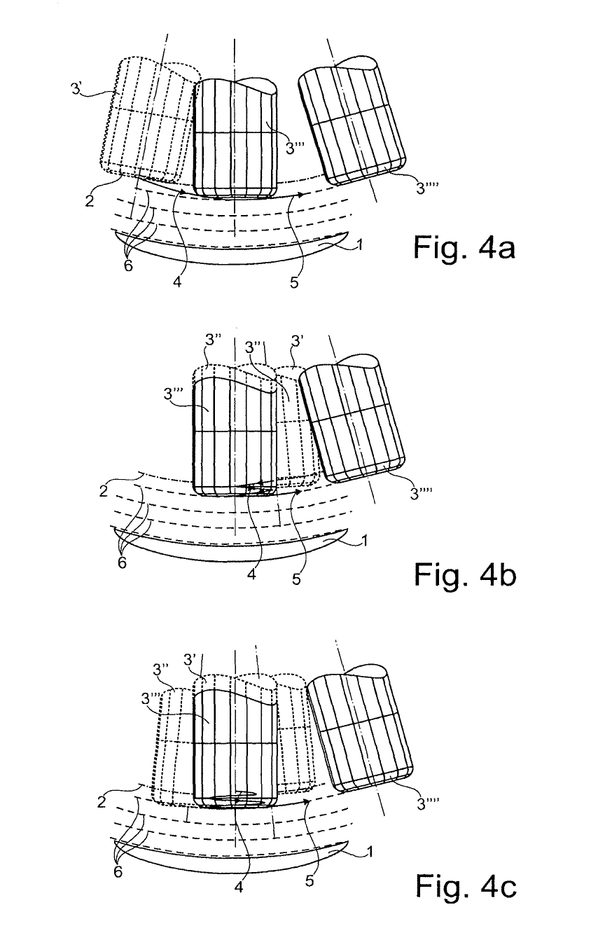

For multiple axes processing, i.e. processing with variable orientation of the tool axis, the tool orientation during the immersion path follows the tool orientation at the first track point and remains unchanged along the entire immersion path, as can be seen in FIGS. 3a to 3c, or the tool orientation follows the global guidance information of the following processing level, as can be seen in FIGS. 4a to 4c.

The immersion ability of a milling tool is defined, apart from position and shape (finish, height) of the front edges, in particular by the ability to discharge the chips generated in front of the milling tool face. Good immersion ability is therefore linked with a weakening of the diameter, which reduces the ability to bear lateral forces and as such also the achievable material removal rate. As a result, high performance milling tools are usually limited in their immersion ability to very low immersion angles, which increases the additional travel paths required for reaching the processing depth and thus the processing time. In particular for small pockets and milling tools that are not cutting over centre, the immersion paths often are not feasible in the required length. Furthermore, in various materials even the immersion at a very low angle can lead to significant milling tool wear and thus to higher milling tool costs and lower process reliability.

It is therefore an object of the present invention to provide a method for immersing a milling tool into a material to be removed from an unmachined part, which allows to avoid the above disadvantages, is able to use milling tools with less wear and increases the process reliability, and/or in particular allows a reliable processing of materials that are difficult to machine, and as a result leads to a significant reduction in production costs.

This object is achieved in a surprisingly simple manner by the characteristics of claim 1.

By the embodiment of the method according to the invention for producing a prefabricated part from an unmachined part by means of a milling tool, wherein the milling tool during the immersion into a material of the unmachined part is being automatically swivelled in advance direction and/or tilted with respect to advance direction and/or sideways to the advance direction in relation to an immersion path differing from the milling tool orientation of the immediately subsequent processing step, axial milling tool loads due to drilling cut conditions during the milling tool's immersion path into the unmachined part material can be completely avoided, or at least significantly reduced. As a result, the method according to the invention is in particular characterized by the benefit that milling tools are used with less wear. At the same time, the process reliability in general is significantly increased with the method according to the invention, and in particular a reliable processing for materials that are difficult to machine is allowed. Finally, the method according to the invention contributes to significantly reducing the production costs.

Further particularly advantageous features of the method according to the invention are described in claims 2 to 15.

According to the characteristics of claim 2, the milling tool is guided along a ramp-shaped immersion path.

In this connection it is envisaged in terms of the invention that the milling tool according to claim 3 is guided along an immersion path that is shaped like a single ramp.

As an alternative embodiment, the milling tool according to claim 4 can be guided along an immersion path that is shaped like a multiple ramp, with a zigzag-, meander- or similarly shaped alternating advance direction moving back and forth.

Furthermore, it is within the framework of the invention that the milling tool according to claim 5 is guided along an immersion path that is shaped like a helix, cylinder, cone or the like.

Preferably the milling tool according to claim 6 is guided along an immersion path that is shaped like a helix but with at least one cycle.

In a beneficial way, the milling tool according to claim 7 is guided along an immersion path that is shaped like a partial helix.

According to the measures of claim 8, the milling tool is guided along an immersion path that is shaped like a partial helix, while a depth advancement is being made in meandering loops in several advancements with changing advance directions.

The milling tool according to claim 9 is guided along an immersion path that is linear and/or circular-shaped.

Alternatively or cumulative, the milling tool according to the characteristics of claim 10 is guided along an immersion path that is shaped like a spline or curve with constant curvature.

Of particular benefit are the measures of claim 11, according to which the immersion path of the milling tool is defined by a circular interpolation for the depth advancement.

Furthermore, it is within the scope of the invention to define the immersion path of the milling tool according to claim 12 by a constant-curvature interpolation for the depth advancement.

According to claim 13, the immersion path of the milling tool is advantageously composed of sections of linear and/or circular and/or constant-curvature interpolated depth advancement.

Furthermore, it is particularly advantageous that the immersion path of the milling tool according to claim 14 is defined by a feed speed differing from the processing path.

Finally, it is preferentially also envisaged according to the invention that the tilt angle of the milling tool according to claim 15 is higher than the inclination angle of the ramp-shaped immersion path. In principle, in order to avoid or reduce drilling cut conditions, a tilt angle of the milling tool is aspired that is higher than the inclination angle of the ramp-shaped immersion path. In order to avoid possible collisions, the milling tool is preferably tilted sideways in relation to the direction of movement. If, however, collisions cannot be avoided in this manner, a lower advance angle may be suitable or even required for reducing drilling cut conditions.

Further characteristics, advantages and details of the invention are contained in the following description of some preferred embodiments of the invention and can be seen in the drawings. The drawings are as follows:

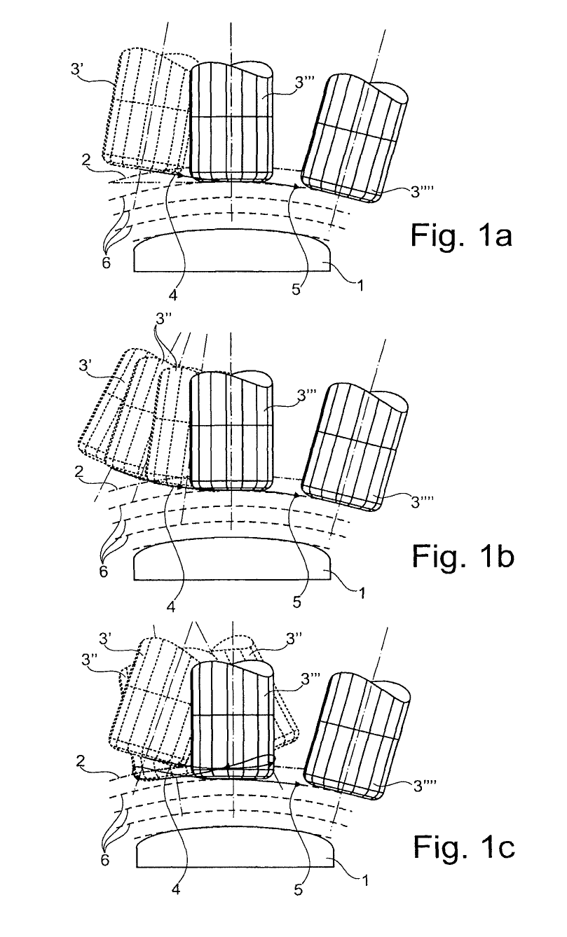

FIG. 1a a schematic view of a milling tool for visualising a method according to the invention for producing a prefabricated part from an unmachined part by means of a milling tool, wherein the milling tool is being immersed into the material of the unmachined part in a ramp-shaped movement, according to FIG. 2a;

FIG. 1b a schematic view of a milling tool for visualising the method according to the invention, wherein the milling tool is being immersed into the material of the unmachined part in a ramp-shaped movement, according to FIG. 1a, with circular interpolation of the depth advancement;

FIG. 1c a schematic view of a milling tool for visualising the method according to the invention, wherein the milling tool is being immersed into the material of the unmachined part in a ramp-shaped movement, according to FIG. 1b, with circular interpolation of the depth advancement in several depth advancements and changing advance directions, while the individual depth advancements are associated with a gentle movement for re-orientating the milling tool;

FIGS. 2a, 2b and 2c schematic views of the milling tool for visualising known methods for 3-axis processing, wherein the milling tool is being immersed in various ways into the material of the unmachined part;

FIGS. 3a, 3b and 3c schematic views of the milling tool for visualising known methods for multiple-axis processing or processing with changing orientation of the tool axis, wherein the milling tool is being immersed in various ways into the material of the unmachined part, while during the immersion the orientation of the milling tool equals unchanged the orientation of the milling tool at the first position after reaching the full depth; and

FIGS. 4a, 4b and 4c schematic views of the milling tool for visualising other known methods for multiple-axis processing or processing with changing orientation of the tool axis, wherein the milling tool is being immersed in various ways into the material of the unmachined part and the milling tool during immersion follows the global rules regarding tool orientation.

In the below description of various embodiments of a method according to the invention for producing a prefabricated part from an unmachined part 2 by means of a milling tool 3, matching equal components are each given identical reference numbers.

Here, the milling tool 3′ is shown at the start of the immersion path, the milling tool 3″ during the immersion path, the milling tool 3′″ at the end of the immersion path and/or at the beginning of the subsequent processing step, and the milling tool 3″″ during the subsequent processing step.

The immersion path of the milling tool 3, that is the tool path during immersion, is given the reference number 4, while the processing path of the milling tool 3, that is the milling tool path during processing, is shown with the reference number 5. The reference number 6 shows various depth advancements of the processing cycle.

FIG. 1a to 1c schematically show the method according to the invention, where the immersion of the milling tool or milling cutter 3 into the material for multiple-axis processing and/or processing with changeable orientation of the tool axis in terms of the object of this invention is shown on the example of a ramp-shaped depth advancement. Deviating from global rules regarding the orientation of the milling tool 3, when processing the relevant level, the tool orientation during immersion follows specifications for avoiding drilling cuts—here as an advance angle in relation to the path.

In this way drilling cut conditions are avoided, or at least significantly reduced.

The path routing and tool orientation are thus separately optimized for the immersion path in relation to the particular cutting conditions during this section in order to avoid the disadvantages of the methods according to the state of the art.

In the simplest case, as can be seen in FIGS. 1a and 1b, the milling tool 3 is automatically tilted according to the angle of the ramp-shaped immersion path 4 in advance direction, while the tilt angle of the milling tool 3 should be higher than the inclination angle of the ramp-shaped immersion path 4. In order to avoid possible collisions, the milling tool 3 is preferably tilted sideways in relation to the direction of movement. Once the processing depth or end of the immersion path 4 is reached, the orientation of the milling tool 3 is adjusted, which is defined for the processing via the global guidance information.

If the depth advancement according to FIG. 1c is done in several steps with changing advance direction, then the immersion path 4 at every change of the advance direction is characterized by an area in which the milling tool 3 is re-orientated in relation to the advance angle and where no depth advancement is made at the milling tool's point of contact. Any change in the lateral inclination may also be done optionally at this point in time.

For a ramp or helix with linear interpolation of the depth advancement, the tilt angle of the milling tool 3 in advance direction—in relation to the machine axes—remains constant during the immersion path 4.

If the immersion path 4 is shaped like a circular section—as shown in FIG. 1b—or a constant-curvature curve and/or if a combined immersion path 4 contains such sections, then the required tilt angle results from the tangent onto the immersion path 4. The tilt angle of the milling tool 3 in advance direction is therefore—in relation to the machine axes—not constant during the immersion path 4. In order to avoid heavy movements of the machine axes, small radii should be avoided for the immersion path 4.

FIGS. 2a to 2c schematically show various known milling methods with immersion modes for 3-axis processing. The orientation of the milling tool 3 remains unchanged. The path to be travelled results from the maximum permissible angle of the milling tool 3 and the depth to be reached. It can be seen clearly that the milling tool 3 during the depth advancement immerses with its front face into the material of the unmachined part 2. Traversing paths back and forth are usually subsequently “added” to the calculated milling tool path of a processing cycle.

Here, FIG. 2a shows the ramp-shaped immersion into the material of the unmachined part 2 as a continuous extension of the subsequent processing path. In this way it can be avoided that the milling tool 3 comes to a short standstill.

FIG. 2b shows the embodiment of the ramp-shaped immersion into the material of the unmachined part when there is no sufficient travel path available for immersing the milling tool 3 according to FIG. 2a. The immersion into the depth is then made by more frequent movement changes, comparable to a zigzag.

FIG. 2c shows a helical immersion of the milling tool 3 into the material of the unmachined part 2. The number of cycles is defined, apart from the depth to be reached and the maximum permissible immersion angle, also by the radius of the helix.

FIGS. 3a to 3c schematically show an immersion of the milling cutter 3 into the material of the unmachined part 2 for multiple-axis processing, i.e. for processing with changeable orientation of the tool axis according to the state of the art, while the orientation of the milling tool at the first track point of the depth to be reached remains unchanged for the entire depth advancement. This movement routing is typical for processing where the tool orientation is defined by normal vectors of surfaces. For such multiple-axis processing, often during the immersion path 4 the orientation of the milling tool 3 at the first track point of the relevant processing depth remains unchanged along the entire immersion path 4. In FIGS. 3a to 3c it can be seen that drilling cut conditions may arise.

FIG. 3a shows the tool orientation during the ramp-shaped immersion into the material of the unmachined part 2 as a continuous extension of the subsequent processing path.

FIG. 3b shows the tool orientation during the ramp-shaped immersion into the material of the unmachined part 2 when there is no sufficient travel path available for immersing the milling tool 3 according to FIG. 2a.

FIG. 3c shows the tool orientation during helical immersion into the material.

FIGS. 4a to 4c schematically show an immersion of the milling cutter 3 into the material of the unmachined part 2 for multiple-axis processing and/or processing with changeable orientation of the tool axis according to the state of the art, while the tool orientation is consistently continued according to the globally defined rules. This movement routing is typical for processing where the tool orientation is defined by curves, points or general rules of collision avoidance. During such multiple-axis processing, for the orientation of the milling tool 3 also the global guidance information of the following processing or processing level is applied, which focus on the cutting conditions during actual processing and avoiding collisions. As can be seen in the examples shown in FIGS. 4a to 4c, also here drilling cut conditions can arise during immersion.

FIG. 4a shows the tool orientation during the ramp-shaped immersion into the material as a continuous extension of the subsequent processing path.

FIG. 4b shows the tool orientation during the ramp-shaped immersion into the material when there is no sufficient travel path available for immersing the milling tool according to FIG. 2a.

FIG. 4c shows the tool orientation during helical immersion into the material.

1-15. (canceled)

16. Method for producing a prefabricated part (1) from an unmachined part (2) by means of a milling tool (3), characterized in that the milling tool (3) during the immersion into a material of the unmachined part (2) is being automatically swivelled in advance direction and/or sideways to the advance direction in relation to an immersion path (4) differing from the orientation (5) of the milling tool (3) of the immediately subsequent processing step.

17. Method according to claim 16, characterized in that the milling tool (3) is being guided along an immersion path (4) that is embodied in the form of a ramp.

18. Method according to claim 16, characterized in that the milling tool (3) is being guided along an immersion path (4) that is embodied in the form of a single ramp.

19. Method according to claim 16, characterized in that the milling tool (3) is being guided along an immersion path (4) that is embodied in the form of a multiple ramp, routed with a zigzag-, meander-shaped or similarly shaped alternating advance direction moving back and forth.

20. Method according to claim 16, characterized in that the milling tool (3) is being guided along an immersion path (4) that is embodied in the form of a helix, cylinder, cone or similar shape.

21. Method according to claim 16, characterized in that the milling tool (3) is being guided along an immersion path (4) that is embodied in the form of a helix with at least one cycle.

22. Method according to claim 16, characterized in that the milling tool (3) is being guided along an immersion path (4) that is embodied in the form of a partial helix.

23. Method according to claim 16, characterized in that the milling tool (3) is being guided along an immersion path (4) that is embodied in the form of a partial helix, while a depth advancement is being made in meandering loops in several advancements with changing advance directions.

24. Method according to claim 16, characterized in that the milling tool (3) is being guided along an immersion path (4) that is embodied in linear and/or circular form.

25. Method according to claim 16, characterized in that the milling tool (3) is being guided along an immersion path (4) that is embodied in the form of a spline or curve with constant curvature.

26. Method according to claim 16, characterized in that the immersion path (4) of the milling tool (3) is defined by a circular interpolation for the depth advancement.

27. Method according to claim 16, characterized in that the immersion path (4) of the milling tool (3) is defined by a constant-curvature interpolation for the depth advancement.

28. Method according to claim 16, characterized in that the immersion path (4) of the milling tool (3) is composed of sections of linear and/or circular and/or constant-curvature interpolated depth advancement.

29. Method according to claim 16, characterized in that the immersion path (4) of the milling tool (3) is defined by a feed speed differing from the processing path (5).

30. Method according to claim 16, characterized in that the tilt angle of the milling tool (3) is higher than the inclination angle of the ramp-shaped immersion path (4).
